(19) United States
(12) Patent Application Publication
(10) Pub. No.: US 2016/0134841 A1
(43) Pub. Date: May 12, 2016

(54) VERIFYING INFORMATION ON AN ELECTRONIC DISPLAY WITH AN INCORPORATED MONITORING DEVICE

(71) Applicants: David Christopher Round, Saline, MI (US); James Paul Farell, Canton, MI (US)

(72) Inventors: David Christopher Round, Saline, MI (US); James Paul Farell, Canton, MI (US)

(21) Appl. No.: 14/537,602

(22) Filed: Nov. 10, 2014

(51) Int. Cl. H04N 7/18; H04N 17/04; B60K 35/00; H04N 5/225

(52) U.S. Cl. CPC H04N 7/18; H04N 5/225; H04N 17/04; B60K 35/00

(57) ABSTRACT

A system and method for verifying information on an electronic display with an incorporated monitoring is disclosed herein. The system includes an image processing interfacer to receive image data from an image processing unit (IPU), the image data being sourced from the monitoring device; a graphical processing interfacer to receive data from a graphical processor unit (GPU) driving the electronic display; a difference analyzer to analyze the difference between the received image data and the received data; and an error indicator to indicate an error based on the difference analyzer. A display assembly for verifying information on an electronic display with an incorporated monitoring is also disclosed herein.

### BACKGROUND

Electronic displays provide information on a lighted panel or surface. The information is received from an electronic control source, such as a processor or display driving circuit, which is configured to render information on the electronic display.

Electronic displays are implemented in many locations, such as a television, computing device, smart phone, and the like. With each implementation, different standards and requirements may be present. For example, in the context of automobiles, certain safety standards may be required.

Previously, in the context of a vehicle, information was conveyed via an instrument panel. The instrument panel is situated in various locations, for example, behind a steering wheel but in front of a driver viewing the front windshield. The instrument panel may be situated in other locations as well.

Conventionally, the instrument panel was a mechanical display. Thus, various mechanically controlled elements were employed to convey information, such as pointers and the like.

However, in recent times, these instrument panels have been augmented or replaced by digital displays. The digital displays allow for the conveying of information via electronic displays. The digital displays employ any sort of electronic display technology known to one of ordinary skill in the art, including but not limited to, liquid crystal displays, light-emitting diodes (LED), organic LEDs, and the like.

Whenever a new technology is implemented in a vehicle or a regulated environment, certain standards and safety precautions may be taken to ensure seamless and safe operations. In vehicles, a governing body may ensure that the safety of a new technology of implementation is above a specific or required threshold. Thus, in certain situations, for example the abandonment of conventional information sharing (i.e. the mechanical gauges or pointers), and the adoption of digital displays to render information—the vehicle manufacturer may be incentivized to ensure safe and consistent operation. This requirement may be internally driven, or be mandated by a regulating board.

### DESCRIPTION OF THE DRAWINGS

The detailed description refers to the following drawings, in which like numerals refer to like items, and in which:

FIG. 1 is a block diagram illustrating an example computer.

FIG. 2 illustrates an example implementation of a system for verifying information on an electronic display with an incorporated monitoring device.

FIG. 3 further illustrates an example of a system for verifying information on an electronic display with an incorporated monitoring device.

FIG. 4 illustrates an example of a method for verifying information on an electronic display with an incorporated monitoring device.

FIG. 5 illustrates an example assembly for verifying information on an electronic display with an incorporated monitoring device.

### DETAILED DESCRIPTION

The invention is described more fully hereinafter with references to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of each” will be interpreted to mean any combination the enumerated elements following the respective language, including combination of multiples of the enumerated elements. For example, “at least one of X, Y, and Z” will be construed to mean X only, Y only, Z only, or any combination of two or more items X, Y, and Z (e.g. XYZ, XZ, YZ, X). Throughout the drawings and the detailed description, unless otherwise described, the same drawing reference numerals are understood to refer to the same elements, features, and structures. The relative size and depiction of these elements may be exaggerated for clarity, illustration, and convenience.

Electronic displays are being situated where traditionally the information has been conveyed mechanically. For example, in the context of a vehicle, the electronic display may be relied upon to replace a mechanical instrument cluster (i.e. with gauges and pointers). Thus, technologies and displays associated with electronic displays, such as graphics, touchscreen capabilities, and the like—may be incorporated for a fuller and more dynamic experience.

As explained in the Background section, the implementation of an electronic display to replace or augment a traditional or conventional mechanical display may necessitate certain precautions for conformity with safety and regulation standards. Thus, in implementing an electronic display in a vehicle, the accuracy of the information on the vehicle may augment the user experience and reliability associated with the operating of the vehicle.

For example, in certain cases, a signal may drive a display being rendered onto the visible portions of the electronic display. However, numerous problems may occur to render the displayed image as inaccurate. For example, the display may be provided with erroneous information, or may render the wrong information based on a hardware or software malfunction associated with the display rendering hardware. In these situations, a viewer of the display may not be cognizant of the display not operating properly. Thus, the viewer may be misled by the display information.

Disclosed herein are methods, systems, and devices for verifying information on an electronic display with an incorporated monitoring device. The monitoring device may be any sort image or video capturing device situated at a location in or around the electronic display. According to the aspects disclosed herein, the image or video capturing device monitors the information rendered on the electronic display. The information may then be verified with information being employed to drive the electronic display. Thus, the aspects disclosed herein employ a verification of information rendered on the electronic display with an independent monitoring system.

The aspects disclosed herein allow electronic displays to conform to various safety standards that require critical or important information being displayed via a vehicle to be verified and ensured for accuracy. Thus, employing the various concepts discussed below allow for information to be disseminated by employment of electronic displays while ensuring that the information is verified and correct.

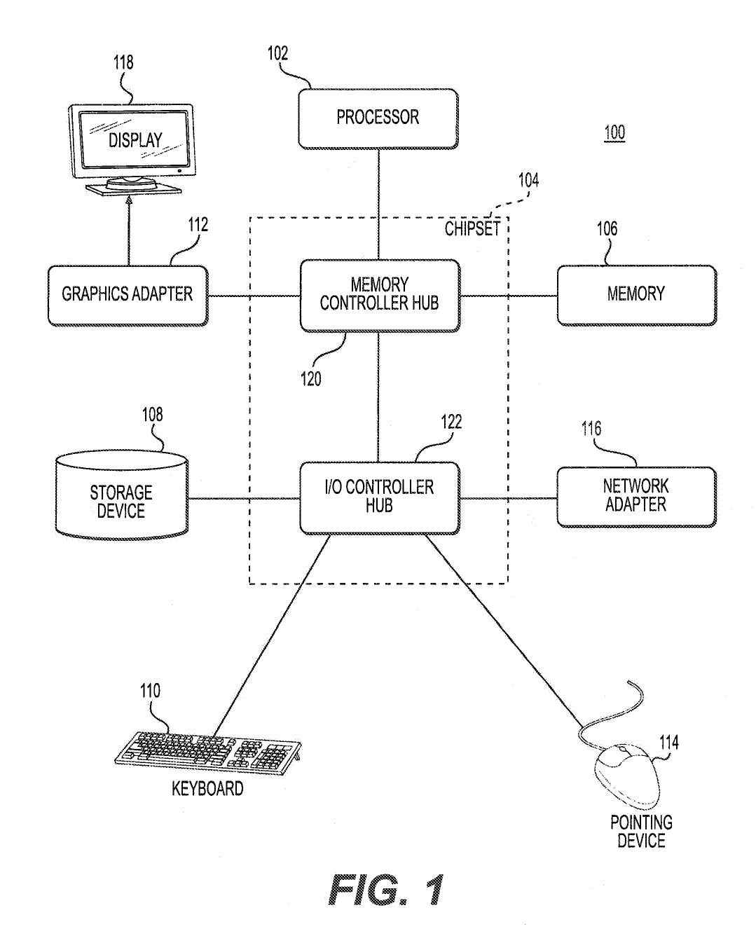

FIG. 1 is a block diagram illustrating an example computer 100. The computer 100 includes at least one processor 102 coupled to a chipset 104. The chipset 104 includes a memory controller hub 120 and an input/output (I/O) controller hub 122. A memory 106 and a graphics adapter 112 are coupled to the memory controller hub 120, and a display 118 is coupled to the graphics adapter 112. A storage device 108, keyboard 110, pointing device 114, and network adapter 116 are coupled to the I/O controller hub 122. Other embodiments of the computer 100 may have different architectures.

The storage device 108 is a non-transitory computer-readable storage medium such as a hard drive, compact disk read-only memory (CD-ROM), DVD, or a solid-state memory device. The memory 106 holds instructions and data used by the processor 102. The pointing device 114 is a mouse, track ball, or other type of pointing device, and is used in combination with the keyboard 110 to input data into the computer 100. The pointing device 114 may also be a gaming system controller, or any type of device used to control the gaming system. For example, the pointing device 114 may be connected to a video or image capturing device that employs biometric scanning to detect a specific user. The specific user may employ motion or gestures to command the point device 114 to control various aspects of the computer 100.

The graphics adapter 112 displays images and other information on the display 118. The network adapter 116 couples the computer system 100 to one or more computer networks.

The computer 100 is adapted to execute computer program modules for providing functionality described herein. As used herein, the term “module” refers to computer program logic used to provide the specified functionality. Thus, a module can be implemented in hardware, firmware, and/or software. In one embodiment, program modules are stored on the storage device 108, loaded into the memory 106, and executed by the processor 102.

The types of computers used by the entities and processes disclosed herein can vary depending upon the embodiment and the processing power required by the entity. The computer 100 may be a mobile device, tablet, smartphone or any sort of computing element with the above-listed elements. For example, a data storage device, such as a hard disk, solid state memory or storage device, might be stored in a distributed database system comprising multiple blade servers working together to provide the functionality described herein. The computers can lack some of the components described above, such as keyboards 110, graphics adapters 112, and displays 118.

The computer 100 may act as a server (not shown) for the content sharing service disclosed herein. The computer 100 may be clustered with other computer 100 devices to create the server. The various computer 100 devices that constitute the server may communicate with each other over a network.

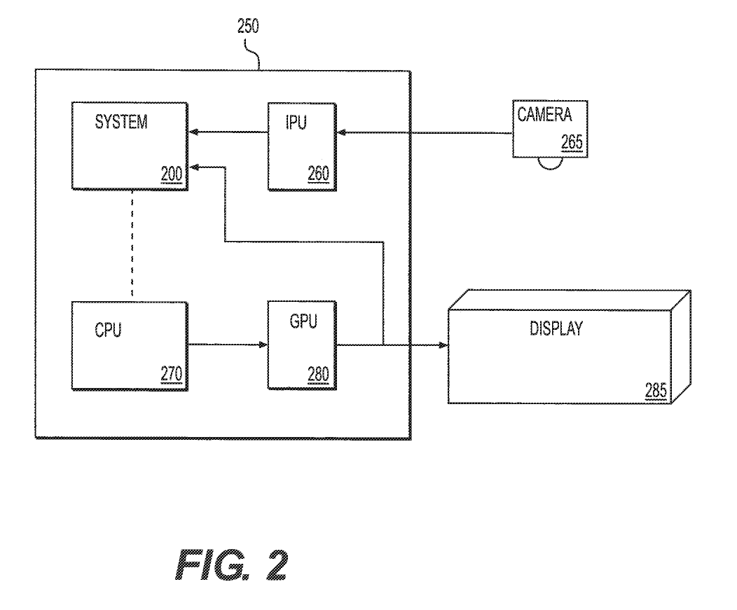

FIG. 2 illustrates an example implementation of a system 200 disclosed herein. The system 200 is incorporated with various electronic componentry associated with an operation of a vehicle. The system 200 and the CPU 270 may be implemented with a computer 100 as described above.

Referring to FIG. 2, a network 250 is provided that allows the various componentry to communicate with each other via a bus. As shown, a system 200 communicates to a camera 265, via an image processing unit (IPU) 260. The system 200 also receives data employed to drive a display 285.

The display 285 is driven by a graphical processing unit (GPU) 280 that receives information from a CPU 270. The CPU 270 may be interfaced with another system, for example the sensors associated with a vehicle (not shown). Thus, whenever electronic systems in a vehicle produce information the information may be sent to the GPU 280 to render information on the display 285.

As shown the camera 265 is oriented to capture information rendered onto the display 285. The information may be captured in real-time, or at predetermined intervals.

The IPU 260, which receives data from the camera 265 may process the image or video to render or capture the information being viewed. In this way, the information on the display 285 may be captured via the camera 265, and interpreted by the IPU 260. The IPU 260 may be configured to perform an analysis based on the image. For example, the IPU 260 may preform character recognition on the display 285 to capture the speed of the vehicle being displayed.

The GPU 280 translates the information received from the CPU 270 to render an image on the display 285. The information employed to render the image is also transmitted to the system 200.

In another example, the CPU 270 may directly communicate the information to the system 200. Thus, the system 200 may receive the information display by either the GPU 280 or the CPU 270.

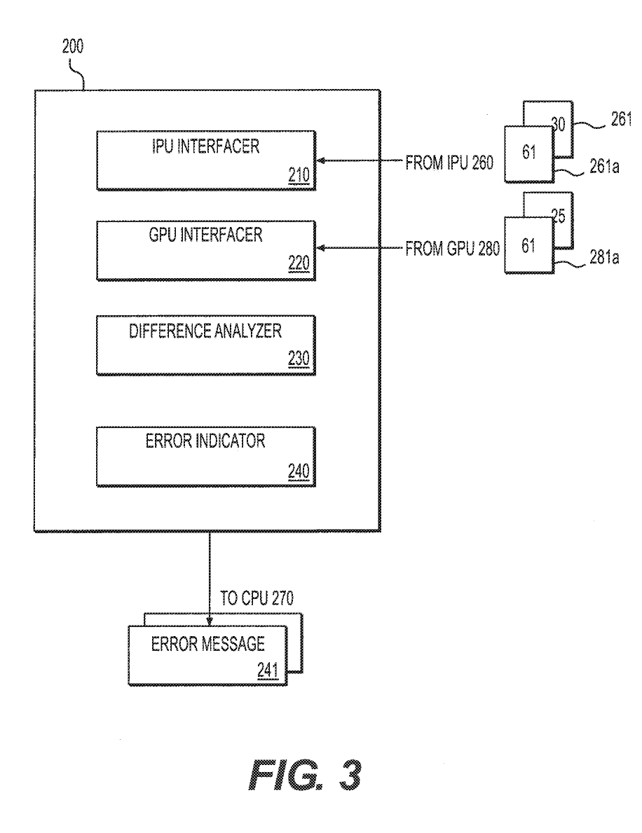

FIG. 3 further illustrates an example of a system 200 for verifying information on an electronic display 285 with an incorporated monitoring device 265. The system 200 includes an image processing unit (IPU) interfacer 210, a graphical processing unit (GPU) interfacer 220, a difference analyzer 230, and a an error indicator 240.

The IPU interfacer 210 receives image data 261 from the IPU 260. The image data 261 may be any sort of digital representation of an image captured by the camera 265 (either an image or video capturing device). The IPU 260 may be equipped with image processing capabilities, so as to interpret the data being captured to ascertain key information. As shown, the image data 261 includes various image files (261A and 261B). Image data file 261A is captured at a first instance, and image data file 261B is captured at a second instance. The image data file 261A is processed and the image processing produces data associated with the image being shown. In this case, the display 285 is being employed to render the speed of the vehicle (as shown as 61). The IPU interfacer 210 may be configured to receive the value 61.

The GPU interfacer 220 receives data file 281 from a GPU 280. The information being received is the information employed to render an image via the GPU 280. For example, if the GPU 280 is instructed via CPU 270 to render an image of 61 MPH, the data file 281 would indicate this. Similar to the image data files (261A and 261B), the data file 281 is shown with data file 281A in a first instance, and data file 281B in a second instance.

The difference analyzer 230 analyzes the difference between the data received by the IPU interfacer 210 and the GPU interfacer 220. The analysis is performed on data received at a similar time period, or within a predetermined threshold of time. For example, if image data file 261a is received at the same time, or within a predetermined time difference, as data file 281a—then the difference analyzer 230 may determine that the value of 61 is similar to both.

However, if a similar analysis is performed on image data file 261b (which indicates a speed of 30) and data file 281b (which indicates a speed of 25), the difference analyzer 230 indicates that the values are not congruous.

The error indicator 240 indicates an error based on the analysis of the difference indicator (for example, in the situation explained above in the analysis of image data file 261b and 281b, where a difference is noted). As shown in FIG. 3, an error message 241 may be communicated via the network 250 to a CPU 270.

Accordingly, the CPU 270 may indicate an error via the display 280, or emit any sort of alerting sound or indication to an operator associated with the vehicle in which the system 200 is associated with. In another example, the CPU 270 may transmit the error message 241 over a network or wirelessly to a third-party. The third-party may then proceed to initiate a diagnostic of the display 280 and the affiliated componentry.

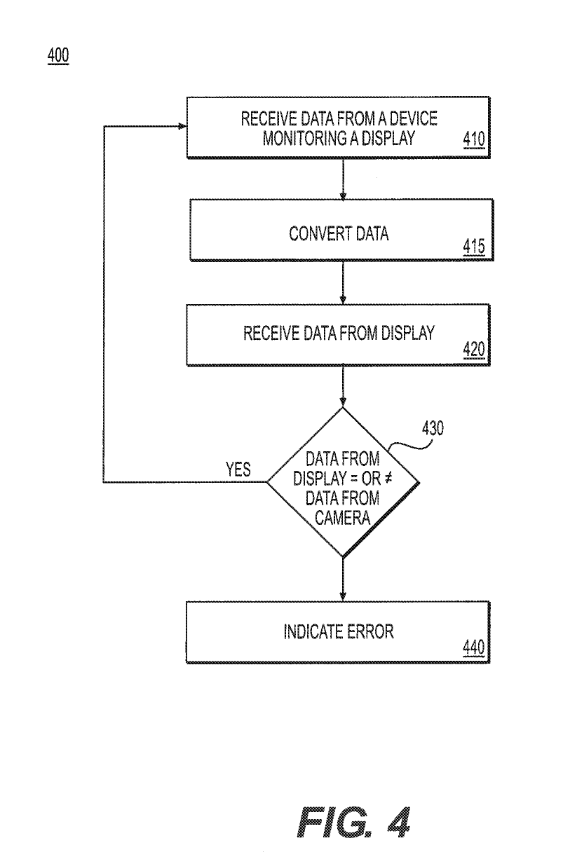

FIG. 4 illustrates an example of a method 400 for verifying information on an electronic display with an incorporated monitoring device. The method 400 may be performed on a device, such as computer 100 described above.

In operation 410, data is received from a device monitoring a display. For example, the device may be an image or video capturing device. The receiving of data may be performed in real-time, or at a predetermined interval.

Alternatively, or in addition to, the initiation of operation 410 may occur due to an external stimulus. For example, if monitoring is initiated via method 400 from a system or an operation, operation 410 may be configured to occur.

In operation 415, the data undergoes a process of converting the image into machine-readable data. For example, if the image is of a speed display, in operation 415, the actual speed associated with the display may be detected.

In operation 420, data being employed to drive a display is received. The data may be stored along with the data received in operation 410 (for example in a lookup table). Data received in operations 410 and 420 may be correlated with each other based on the time the data is received.

In operation 430, a determination is made as to whether the data received in operation 410 matches the data received in operation 420. If the data matches, the method 400 proceeds to operation 410, and awaits a receiving of additional data. If the data does not match, the method 400 proceeds to operation 440.

In operation 440, a message indicating that the data does not match (i.e. an error message such as error message 241) is transmitted. The error message 241 may be employed by a CPU driving the electronic display associated with method 400, and indicated in various ways, such as those known to one of ordinary skill in the art. Accordingly, employing the aspects discussed in method 400, an error associated with an electronic display may be effectively detected and messaged.

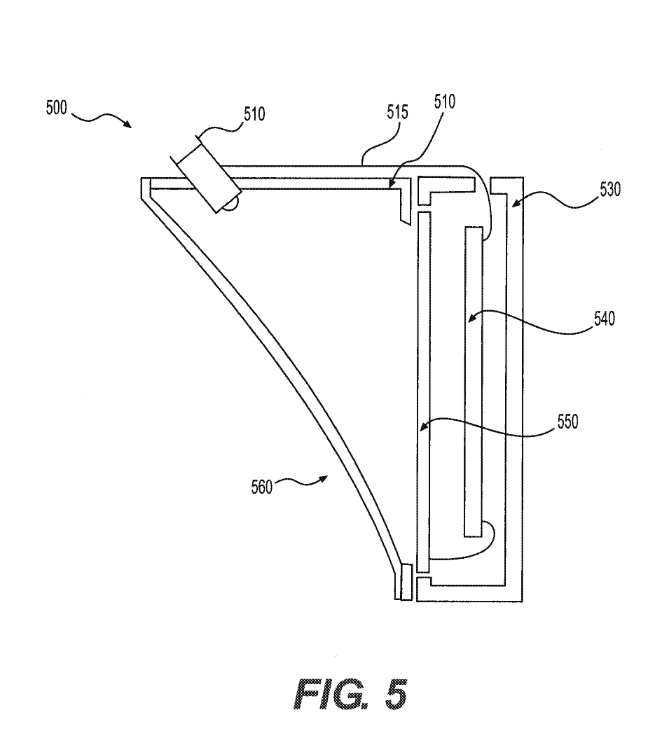

FIG. 5 illustrates an example assembly 500 for verifying information on an electronic display with an incorporated monitoring device. The assembly 500 may be implemented in a vehicle (not shown), and employed to convey information about the vehicle's operation and present state. This may include, but not limited to, the speed of the vehicle, RPM, fuel level, engine indication, or the like.

The assembly 500 includes a camera 510 mounted on a mask 520. The mask 520 allows the camera 510 to be obscured from view, while being orientated at a display 550. The display 550 corresponds to the electronic display 285 discussed above, and the camera 510 corresponds to the image capturing device 265 discussed above. The electronics 540 may allow the camera 510 to communicate via bus 515 to the display 550. The electronics 540 may incorporate any of the componentry or methods discussed in FIGS. 2-4.

The assembly 500 may also include a lens 560 and a back plate 530. The back plate 530 may be equipped to allow the bus 515 (i.e. electronic wiring) to couple to the camera 510. The lens 560 may further aid in obscuring the camera 510 from an operators view.

As shown in FIG. 5, the elements incorporated in the assembly 500 may be machined and shaped to be installed on the contours of a dashboard of a vehicle. Thus, the display 550 may be integrated as an instrument panel associated with the vehicle.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

We claim:

1. A system for verifying information on an electronic display with an incorporated monitoring device, comprising:
an image processing interfacer to receive image data from an image processing unit (IPU), the image data being sourced from the monitoring device;
a graphical processing interfacer to receive data from a graphical processor unit (GPU) driving the electronic display;
a difference analyzer to analyze the difference between the received image data and the received data; and
an error indicator to indicate an error based on the difference analyzer.

2. The system according to claim 1, wherein the monitoring device is a camera.

3. The system according to claim 2, wherein the camera is orientated to face the electronic display.

4. The system according to claim 1, wherein the electronic display is installed in a vehicle.

5. The system according to claim 4, wherein the data corresponds to the vehicle's operation.

6. The system according to claim 5, wherein the vehicle's operation is at least one of a speed of the vehicle, a light associated with the vehicle's operation, a check engine light, and a RPM of the vehicle.

7. The system according to claim 4, wherein the electronic display and the camera are installed on a dashboard of the vehicle.

8. A method for verifying information on an electronic display with an incorporated monitoring device, comprising:
receiving image data from an image processing unit (IPU), the image data being sourced from the monitoring device;
receiving data from a graphical processor unit (GPU) driving the electronic display;
determining if a difference between the received image data and the received data exists; and
indicating an error based on a determined difference existing.

9. The method according to claim 8, wherein the monitoring device is a camera.

10. The method according to claim 9, wherein the camera is orientated to face the electronic display.

11. The method according to claim 8, wherein the electronic display is installed in a vehicle.

12. The method according to claim 11, wherein the data corresponds to the vehicle's operation.

13. The method according to claim 12, wherein the vehicle's operation is at least one of a speed of the vehicle, a light associated with the vehicle's operation, a check engine light, and a RPM of the vehicle.

14. The method according to claim 13, wherein the electronic display and the camera are installed on a dashboard of the vehicle.

15. An display assembly, comprising:
a display to render electronic images;
an electronic circuit to drive the display; and
a camera orientated at the display to capture the electronic images,
wherein the electronic circuit is configured to compare the electronic images and the captured electronic images to determine whether the display is operating correctly.

16. The display assembly according to claim 15, wherein the camera is mounted on a mask.

17. The display assembly according to claim 16, wherein the mask is installed around the display.

18. The display assembly according to claim 16, further comprising a lens, the camera being between the lens and the display.
